(19) United States
(12) Patent Application Publication
(10) Pub. No.: US 2008/0282575 A1
(43) Pub. Date: Nov. 20, 2008

(54) Multistage Continuous Dryer, Especially For Plate-Shaped Products

(75) Inventors: Alfred Dotzler, Wangen (DE); Anton Hecht, Lindau (DE)

Correspondence Address: FASSE PATENT ATTORNEYS, P.A., P.O. BOX 726, HAMPDEN, ME, 04444-0726, US

(73) Assignee: LINDAUER DORNIER GESELLSCHAFT MBH, LINDAU (DE)

(21) Appl. No.: 11/918,422

(22) PCT Filed: Apr. 11, 2006
(86) PCT No.: PCT/DE2006/000639

§ 371 Date: Oct. 12, 2007

(30) Foreign Application Priority Data
Apr. 13, 2005 (DE) 10-2005-017-152.4

(51) Int. Cl. F26B 3/04; F26B 15/12; F26B 21/02

(52) U.S. Cl. 34/477; 34/501; 34/77; 34/210; 34/212; 34/215; 34/216

(57) ABSTRACT

The invention relates to a method for the drying of water-containing, preferably plate-shaped products in a throughflow dryer in multi-level construction, and such a dryer for carrying out the method. The invention aims to suck away moist air stagnated under the housing (2) in a dyer of the above mentioned type and to transport this moist air into the suction area (12) of the axial blowers (9) arranged in the lower levels, and thereupon to differentially admix moist air into a quantity of drying air and deliver it to the nozzle boxes (5) of the dryer.

The invention relates to a throughflow dryer in a multi-level construction for especially plate-shaped products, with means, especially rollers or belt-like means, for the transport of the products within the throughflow dryer, whereby the throughflow dryer has several dryer zones which comprise a housing and which are arranged behind one another in a transport direction of the products, and in which drying air circulates in an air circulation method, whereby each dryer zone comprises at least one central heat source and several axial blowers arranged vertically over one another in a blower stand, which axial blowers convey the drying air in a direct path into inflow openings of nozzle boxes arranged over and under the transport means for the blowing of the plate-shaped products, and again suck in the moisture laden drying air over the at least one heat source.

Throughflow dryers with the above mentioned features have long been known, also see “Die richtige Lösung für die Bauplatten-Industrie”, (“The Right Solution for the Construction Panel Industry”), prospectus of Lindauer DORNIER GmbH, page 6/7, imprint 12/01/LD/02/99.

In the known multi-level throughflow dryers, in which moisture is withdrawn or extracted from the products to be dried by high-temperature tempered or heated air, the moisture laden air proceeds in an air circulation loop as low temperature tempered or heated air to the at least one heat source and thereafter as high temperature tempered air back to the blowers.

Measurements for determining the residual moisture in the products, which leave the throughflow drier at the end of the drying process, have shown that products that pass through the dryer in the lower levels of the throughflow dryer have a smaller residual moisture than products that pass through the throughflow dryer in the upper levels. The cause of the differing residual moisture in the finished dried products is to be searched for in the fact that a portion of the moisture laden tempered circulation air, due to its thermodynamic characteristics, stagnates in the upper levels of the throughflow dryer. Thus, the stagnant circulation air can contain, for example, 40 grams of H₂0 per 1 kg of air. Because this circulation air comprising a relatively high saturation degree of water is positively again directed to the product by means of the blowers allocated to the upper levels through the blowing boxes of the upper levels, the moist drying air blown onto the product to be dried cannot withdraw or extract the desired water quantity from the products. Accordingly, the dried products exit with a differing proportion or content of residual moisture corresponding to the levels of the dryer that were passed through. The invention of the patent application comes into play at this point.

The object underlies the invention, in a multi-level dryer embodied as a throughflow dryer according to the features of the preamble of patent claim 1 and 4, to provide such conditions that the proportion or content of the residual moisture in the dried products is nearly constant at the end of the drying process, independent of the level of the throughflow dryer that was passed through.

The object is achieved according to the invention by the characterizing features of patent claim 1 and 4.

According to patent claim 1, the moist air that stagnates below the upper horizontal housing preferably of each dryer zone is sucked off and differentially admixed into the drying air that is to be delivered to the lower levels. The admixture is carried out in such a manner that the quantity of the admixed moist air is the largest in the first level of the dryer zone, while the admixing diminishes in the direction of the upper levels. The moist air quantity per each suction area of the axial blower in that regard can amount to up to approximately 30% of the drying air quantity that can be sucked in by the axial blower.

According to patent claim 4, a vertically extending air channel that is dimensioned sufficiently large in its cross-section is integrated in a vertically extending part of the housing of at least several dryer zones and particularly in the area of the housing of the blower stands. In that regard, the free end of the air channel lying opposite to the horizontally extending part of the housing, forms, spaced away from the housing part, an inflow opening for the circulation air saturated with water (stagnant moist air). In order to be able to suck in or away the water saturated circulation air through the inflow opening, the air channel has, in the channel wall of the air channel lying opposite to the immediate or direct suction area of each blower, openings for the differentiated sucking-in of the moisture laden circulation air that is stagnated under the horizontal part of the housing. In embodiment of the inventive solution, it is provided that the cross-sectional shape of the openings is freely selectable and that the size of the opening can be adjustable.

Further it is provided according to the invention, that for non-adjustable openings, the size of the openings diminishes in the direction of the inflow opening of the air channel.

With the inventive solution, in an advantageous manner, the water saturated circulation air stagnated under the horizontal housing is sucked in the direction of the lower levels of the throughflow dryer, and is differentially directed or introduced to the circulation air flowing over the heat source. In this manner, a nearly uniform residual moisture is achieved in the products, independent of which level the product to be dried passes through in the throughflow dryer.

The invention will be explained in more detail in the following in connection with an example embodiment.

In the drawings:

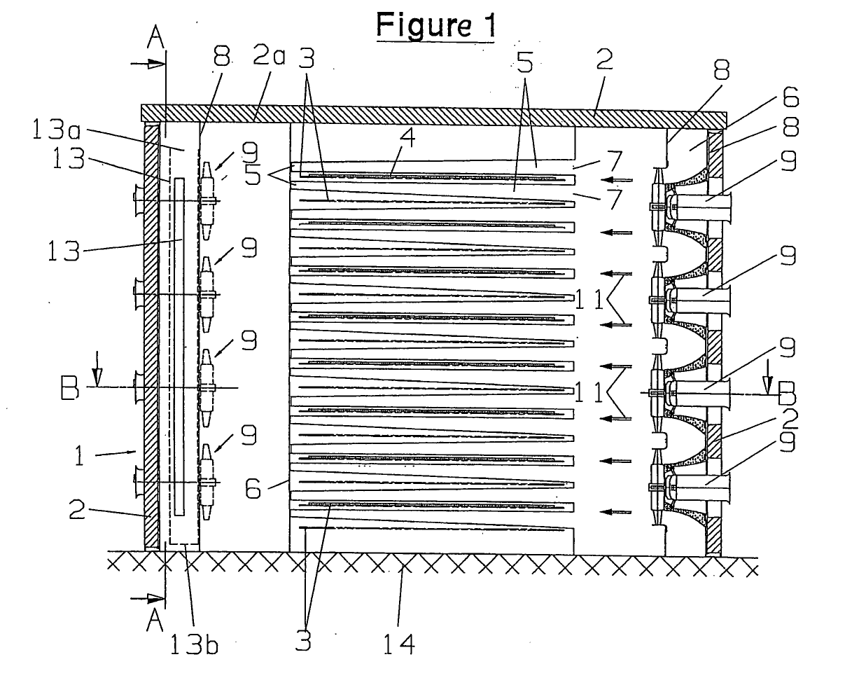

FIG. 1 shows the sectional illustration of a throughflow dryer in a multi-level construction with axial blowers in a vertical arrangement,

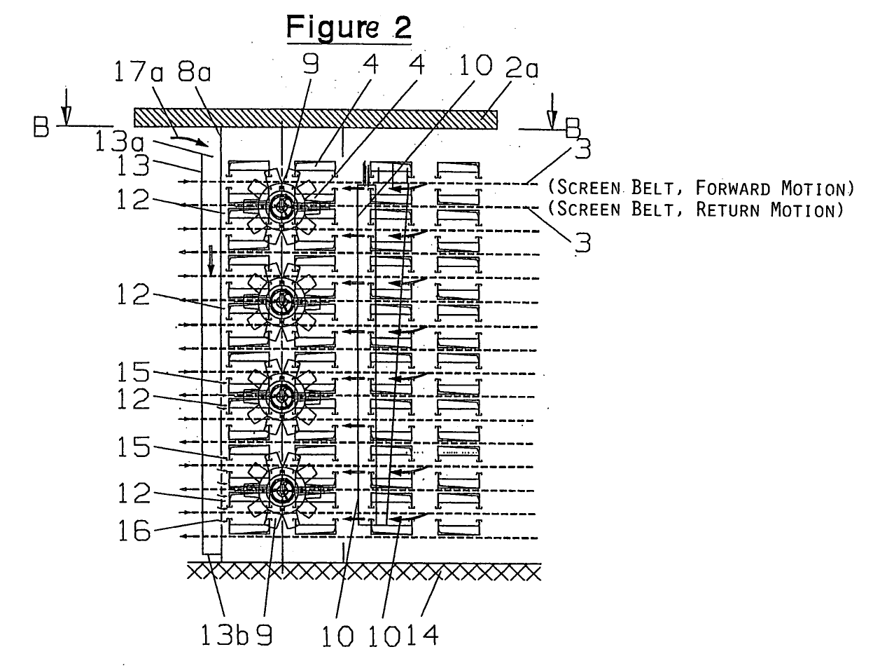

FIG. 2 shows the air channel integrated according to the invention in a dryer zone of the throughflow dryer according to FIG. 1 along line A-A,

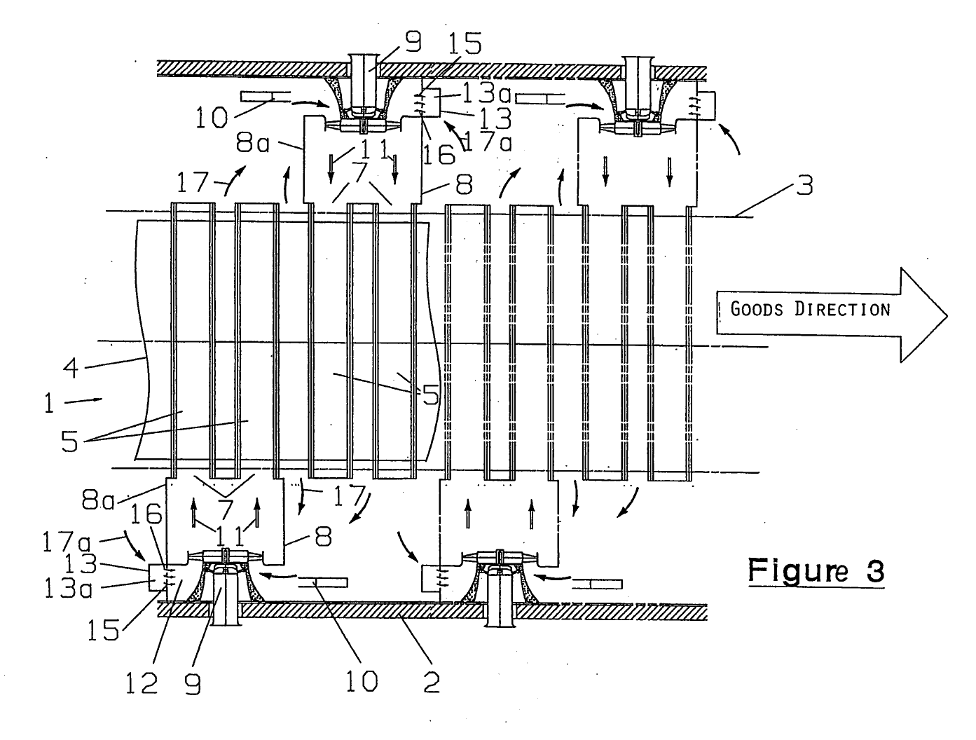

FIG. 3 shows the top view of a dryer zone along line B-B in FIG. 2,

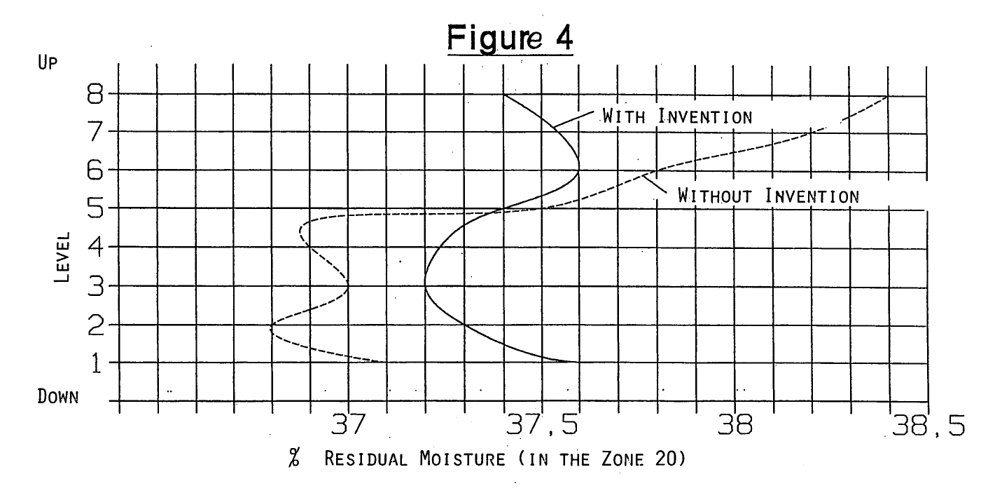

FIG. 4 shows a diagram with a comparative illustration of the residual moisture content in the dried product with and without the inventive solution.

In the dryer zone 1, schematically illustrated according to FIG. 1, of a multi-level throughflow dryer consisting of several such dryer zones, each dryer zone comprises a housing 2. The housing 2 consists of one horizontally and several vertically extending heat insulation walls, and encloses several dryer levels. A screen belt endlessly running around rollers, which are not illustrated, as transport means 3 for the product 4 to be dried, for example a fiber panel, is guided in each dryer level. The individual transport means 3 embodied as screen belts are driven by means that are not shown here. Furthermore, over the length of the dryer zone 1, several pairs of so-called nozzle boxes 5 are arranged on a frame-like rack or stand 6 under and over the transport means 3. On its one end, each nozzle box 5 has an inflow opening 7, while its other end is closed. Each nozzle box 5 comprises outflow openings lying opposite the transport means 3, in the present case the screen belt. Below the housing 2, in each dryer zone, at least one blower stand 8 with several axial blowers 9 arranged vertically over one another is installed, blow the drying air that is heated by at least one heat source 10 in an air circulation method into the nozzle boxes 5, as indicated by the direction arrows 11. The drying air that is heated and blown into the nozzle boxes comes onto the product 4, as explained above, via so-called slit or slot nozzles or otherwise embodied openings of the blower boxes 5, that lie opposite to the transport means 3 or the product lying on the transport means, whereby the drying air withdraws or extracts from the product 4 the moisture contained therein, down to a percentage residual moisture proportion or content, which the product 4 comprises at the end of the dryer process.

The disadvantages arising in the drying process of plate-like products in such a multi-level throughflow dryer are already represented in the prior art insofar as the thermodynamic behavior of the moisture laden drying air leads to the condition that drying air with a high moisture content stagnates under the horizontally extending housing 2 of the throughflow dryer 1, namely under the ceiling thereof, and this stagnating drying air is again directed or introduced into the horizontally circulating circulation air in the upper levels of the throughflow dryer.

The result is that the relative moisture content in the products at the end of the drying process is differently or variously large and can only be compensated or evened-out through a high technical effort or expenditure, for example on the heat sources. While the products 4 running through the dryer in the lower levels, for example in the twentieth zone of thirty total, have a residual moisture of approximately 36%, the products of the upper levels comprise an increasingly higher residual moisture of, for example, 39%.

The inventive measure shown in FIG. 2 removes or avoids the differences with respect to the proportion or content of the residual moisture in the products 4. A longitudinal section according to the line A-A in FIG. 1 makes it clear in FIG. 2 that a flow channel 13 with an inflow opening 13a facing toward the housing ceiling, which channel extends over all levels and ends with a spacing distance below the inner side of the horizontal housing 2a, is arranged on the side of the axial blower suction areas 12 facing away from the heat source 10, as best to be seen in FIG. 3, and particularly on the wall 8a of the blower stand 8. The other end 13b of the flow channel 13 facing toward the foundation 14 of the dryer zone 1 is closed.

For making the proportion or content of the residual moisture in the products 4 uniform, it is provided according to the invention to introduce openings 15 into the wall 8a of the blower stand 8 carrying the suction channel 13, and particularly in the area of the blower suction areas 12, to differentially suck away the drying air, which comprises a high moisture proportion or content and is stagnated under the housing ceiling, through the openings 15 and the inflow opening 13a, and to direct or introduce this drying air into the circulation air circuit or loop of the lower levels, as this is indicated with the direction arrows 16.

In FIG. 3 shows 2 dryer zone 1 of a throughflow dryer according to the line B-B in FIG. 2. The inflow openings 7 of the respective two pairs of nozzle boxes 5 are connected over the totality of the levels of the dryer zone 1 to a blower stand 8 embodied in the manner of an air channel.

The drying air according to direction arrow 11 flows over the product 4 to be dried and takes up moisture therefrom. The direction arrows 16 symbolize the moisture laden drying air. A portion of the moisture laden drying air according to the direction arrow 17 is directed over the heat source 10 and is again directed or supplied as drying air according to the direction arrow 11 to the drying of the product 4. A different portion of the moisture laden drying air stagnates according to the direction arrow 17a under the ceiling of the applicable dryer zone 1. This portion of moisture laden drying air is sucked away through the openings 15 and the flow channel 13 by means of the axial blowers 9, and is admixed to the drying air according to direction arrow 17a.

FIG. 4 depicts, in a diagram, the measured proportion or content of the residual moisture in a plate-shaped product after or according to 20 dryer zones of a level throughflow dryer consisting of, for example, 30 dryer zones and having an essentially horizontal air circulation loop or circuit, without and with the inventive solution. The percentage proportion or content of the residual moisture is entered on the abscissa of the diagram while the number of the levels is indicated on the ordinate. The temperature of the drying air amounted to approximately 350° C. The temperature of the moisture laden drying air amounted to approximately 280° C. Without the inventive solution, after ⅔ of the dryer length in the lower levels, to which the levels 1 to 5 belong in the present case, the proportion or content of measured residual moisture in the product 4 amounted to between 36.8% and 37.5%, while the proportion or content of the residual moisture in the product of the levels 6 to 8 was already between 37.8% and 38.4%. Thus, a clearly or considerably differing proportion or content of the residual moisture is present after the drying process, as is shown by the dashed line in the diagram. The inventive solution has made clear in a surprising manner, that the proportion or content of the residual moisture in the products of the lower levels of the dryer is slightly larger, but could be clearly or considerably reduced in the levels 6 to 8, as is shown by the continuous or solid line in the diagram. Thus, in an advantageous manner, with the inventive solution a uniform residual moisture in the panels is achieved over all levels. This leads to increasing the production quantity with the same energy input. Moreover, an improvement of the quality of the products is achieved.

It is still further pointed out that the above disclosed invention is also useable for products from which no water needs to be withdrawn or extracted, but rather that merely need to be subjected to a thermal treatment (thermobonding). In this case, the air channel integrated in the blower stand can act opposite to or counteract the thermally re-tempered air and cause the air temperature in the dryer levels to become uniform.

1. Method for the drying of water-containing, preferably plate-shaped products in a throughflow dryer in multi-level construction, whereby the drying takes place by means of high temperature tempered drying air in an air circulation method, which drying air is sucked in by axial blowers and is directed through inflow openings of several nozzle boxes arranged above and below a transport plane in each level, and flows onto the product out of at least one nozzle of the applicable nozzle box facing in the direction of the products, thereupon withdraws moisture from the product and thereafter the moisture laden drying air flows over a heat source back to the axial blowers, and whereby due to thermodynamic characteristics a portion of the moisture laden drying air stagnates in the area of the upper level of the dryer, characterized in that the stagnated moist air is sucked away and comes into the suction area of the axial blowers arranged in the lower levels, and in that thereupon the moist air is differentially admixed into the drying air and directed to the nozzle boxes of at least one level.

2. Method according to claim 1, characterized in that the admixed quantity of the moisture laden air to the drying air is largest in the first level and diminishes in the direction of the upper levels.

3. Method according to claim 2, characterized in that the moist air quantity per each suction area of the blower amounts to less than 30% of the drying air quantity than can be sucked-in.

4. Dryer, especially multi-level dryer for preferably plate-shaped products (4), with means (3), especially rollers or belt-like means for the transport of the products within the dryer, whereby the dryer consists of several dryer zones (1) that comprise a housing (2) and that are arranged behind one another in the transport direction of the products, in which dryer zones drying air circulates in the air circulation method, whereby each dryer zone has at least one central heat source (10) and several axial blowers (9) arranged vertically above one another in a blower stand (8), which axial blowers convey the drying air in a direct path into inflow openings (7) of nozzle boxes (5) arranged preferably pair-wise over and under the transport means, for blowing the plate-shaped products, and again suck in the moisture laden drying air over the at least one heat source, characterized in that a vertically extending air channel (13) is integrated in the housing of the blower stand, wherein the free end of the air channel forms an inflow opening (13a) spaced apart from the inner side of the upper horizontal housing, and whereby the channel wall of the air channel lying opposite the suction area (12) of each axial blower (9) comprises openings (15) for the differentiated sucking-in of the moisture laden circulation air.

5. Dryer according to claim 4, characterized in that the cross-sectional shape of the openings (15) is selectable as desired.

6. Dryer according to claim 4, characterized in that the size of the openings (15) is adjustable.

7. (canceled)

8. Dryer according to claim 4, characterized in that the size of the cross-section of the openings (15) diminishes in the direction of the inflow opening (13a) of the air channel (13).
